(19) United States
(12) Patent Application Publication
(10) Pub. No.: US 2025/0243357 A1
(43) Pub. Date: Jul. 31, 2025

(54) ULTRA-STRETCHABLE HOP-RING HYDROGELS

(71) Applicant: Trustees of Dartmouth College, Hanover, NH (US)

(72) Inventors: Chenfeng Ke, Saint Louis, MO (US); Dan Zheng, Saint Louis, MO (US); Zhuoran Zhong, Hanover, NH (US)

(73) Assignee: Trustees of Dartmouth College, Hanover, NH (US)

(21) Appl. No.: 19/041,794

(22) Filed: Jan. 30, 2025

Related U.S. Application Data
(60) Provisional application No. 63/627,316, filed on Jan. 31, 2024.

(51) Int. Cl. C08L 33/26; B33Y 10/00; C08L 5/16; C08L 71/02

(52) U.S. Cl. CPC C08L 33/26; B33Y 10/00; C08L 5/16; C08L 71/02

(57) ABSTRACT

The present disclosure pertains to a rotaxane composition that includes a plurality of macrocyclic rings, a plurality of macrocycle-binding moieties, and a plurality of first polymers and second polymers. The macrocyclic rings and macrocycle-binding moieties are reversibly threaded onto the first polymers. At least some of the macrocyclic rings are operational to unthread from one first polymer and rethread onto another first polymer or a second polymer. The present disclosure also pertains to methods of manufacturing a three-dimensional structure by applying a rotaxane composition onto a surface. The present disclosure also pertains to methods of forming the rotaxane compositions.

### CROSS-REFERENCE TO RELATED APPLICATIONS

This application claims priority to U.S. Provisional Patent Application No. 63/627,316, filed on Jan. 31, 2024. The entirety of the aforementioned application is incorporated herein by reference.

### STATEMENT REGARDING FEDERALLY SPONSORED RESEARCH

This invention was made with government support under DE-SC0022267 awarded by the U.S. Department of Energy. The government has certain rights in the invention.

### BACKGROUND

A need exists for ultra-tough and stretchable polymeric networks, which do not suffer from early fracture of covalent linkers, weak bonding strength, and limited molecular mobility or chain flexibility. Numerous embodiments of the present disclosure aim to address the aforementioned need.

### SUMMARY

In some embodiments, the present disclosure pertains to a rotaxane composition that includes a plurality of macrocyclic rings, a plurality of macrocycle-binding moieties, and a plurality of first polymers and second polymers. In some embodiments, the plurality of macrocyclic rings and the plurality of macrocycle-binding moieties are reversibly threaded onto the first polymers. In some embodiments, at least some of the plurality of macrocyclic rings are operational to unthread from one first polymer and rethread onto another first polymer or a second polymer.

Additional embodiments of the present disclosure pertain to methods of manufacturing a three-dimensional structure by applying a composition of the present disclosure onto a surface to result in the formation of the three-dimensional structure on the surface. In some embodiments, the applying occurs by additive manufacturing. In some embodiments, the methods of the present disclosure also include a step of covalently cross-linking the three-dimensional structure.

Additional embodiments of the present disclosure pertain to methods of forming the rotaxane compositions of the present disclosure. In some embodiments, such methods include: (1) reversibly threading a plurality of macrocyclic rings and a plurality of macrocycle-binding moieties onto a plurality of first polymers such that they become reversibly threaded onto the first polymers; and (2) associating the first polymers with a plurality of second polymers.

### BRIEF DESCRIPTION OF THE DRAWINGS

FIG. 1 provides an illustration of a rotaxane composition of the present disclosure.

FIG. 2 illustrates the design of a hop-ring network and its optimal mechanical properties over covalent, non-covalent, double network, and slide-ring systems.

FIG. 3A illustrates uniaxial stress-strain curves of hop-ring and other control gels.

FIG. 3B shows a ring-hopping mechanism that contributed to both stretchability and elasticity of hop-ring hydrogels.

FIGS. 4A-4D show the effects of threading cyclodextrin (CD) number per polyethylene glycol (PEG) axle (FIG. 4A), crosslinking density (FIG. 4B), polyacrylamide (PAAm) entanglements (FIG. 4C), and water content on extension performances of hop-ring hydrogels (FIG. 4D).

FIGS. 5A-5D show hysteresis loop of loading-unloading cycle with varying extension ratio (FIG. 5A), small-angle x-ray scattering (SAXS) measurement under loading-unloading (FIG. 5B), effects of PEG axles with varying molecular weights when CD/PEG=1.4/1 (FIG. 5C), and effects of PEG axles with varying molecular weights when CD/EG=1/100 (FIG. 5D).

FIGS. 6A-6D show the LCD-printing of hop-ring and covalent hydrogels (FIG. 6A), stress-strain curves of printed dumbbell specimens (FIG. 6B), a printed self-standing lattice structure (FIG. 6C), and printed hollow cylinders and their pneumatic behavior (FIG. 6D).

FIGS. 7A-7B show nominal stress-strain curves of covalently crosslinked polyacrylamide CN hydrogels (FIG. 7A) and physically crosslinked polyacrylamide LP hydrogels (FIG. 7B). Images of the notched CN and LP samples upon stretching are shown below.

FIG. 8A shows nominal stress-strain curves of the hop-ring HRAAm hydrogels and images of the notched HRAAm samples upon stretching. FIG. 8B shows a comparison of the fracture energies among CN, LP, and HR hydrogels.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Polymer networks have a broad spectrum of properties and applications to showcase their versatility and potential. Derived from various types of molecules, junctions (also named “crosslinkers”), network structures, and mesh topologies, polymer networks can be classified into four types. Covalent networks consist of polymer strands connected by crosslinkers with multiple covalent bonds. Physical networks are polymers interconnected by non-covalent interactions, including hydrogen bonding, host-guest interaction, electrostatic interactions, metal-ligand coordination, micro-crystallization, and van der Waals forces. Hybrid networks, or double networks, encompass a great amount of hybrid systems combining both covalent and/or non-covalent networks. Topological networks, other than crosslinked by molecular bonds, are formed by movable crosslinkers retaining the mobility of subcomponents in the crosslinking entities. For example, slide-ring networks are crosslinked by movable polyrotaxanes containing sliding rings on axles.

Research advancements in crosslinked polymers have greatly expanded the properties and performances of functional materials. Significant progresses have led to the development of rigid, soft, tough, flexible, self-healable, recyclable, and multi-responsive elastomers and gels for various applications. Covalent crosslinkers stiffen but embrittle networks due to the intrinsic stiffness and extensibility trade-off.

In order to create covalent hydrogels that are strong and less brittle, researchers have successfully utilized dense chain entanglements and low crosslinking densities to improve toughness and wear resistance. However, the maximum length that a covalent network can be stretched is still limited by the counter length of polymer strands in theory.

Non-covalent crosslinkers are dynamic and readily reversible, supplying a wide range of stretchable, recoverable, and self-healing materials. Nonetheless, issues from weak bond strengths within physical structures is hard to overcome.

In order to compromise large deformations and energy dissipation through the fast break/reform dynamics at junction sites, most physical hydrogels exhibit low strengths and insufficient toughness. In double-network materials, incorporating a loosely-crosslinked covalent network or combining a physical network with a covalent network significantly improved the toughness of hybrid network systems. The maintained structure of the rigid covalent network and the internal fracture of the soft (non) covalent network are preferred for the toughening mechanism. However, the rigid network is the limiting factor for mechanical properties, of which the brittleness and limited extensibility restrict the overall stretchability and toughness of the systems.

Slide-ring networks introduced a novel topological method to build tough and reversible crosslinked polymers. The topologically interlocked crosslinkers consist of linked cyclodextrins (CDs) threaded on polyethylene glycol (PEG) chains. The ring components can slide on PEG chains to resist deformation and stress. However, the movement of crosslinkers is restricted along the PEG chain to which they are linked. Moreover, the extent of the sliding motion and polymer flexibility are confined by factors such as the inter-branch distance of PEG and the number of threaded CDs per chain.

As such, a need exists for ultra-tough and stretchable polymeric networks that do not suffer from early fracture of covalent linkers, weak bonding strength, and limited molecular mobility or chain flexibility. Overcoming such challenges by designing novel polymeric network systems can enhance the mechanical properties and overall performance of polymeric materials, and therefore push the boundaries and unlock new possibilities in scientific investigations and potential applications. Numerous embodiments of the present disclosure aim to address the aforementioned need.

### Rotaxane Compositions

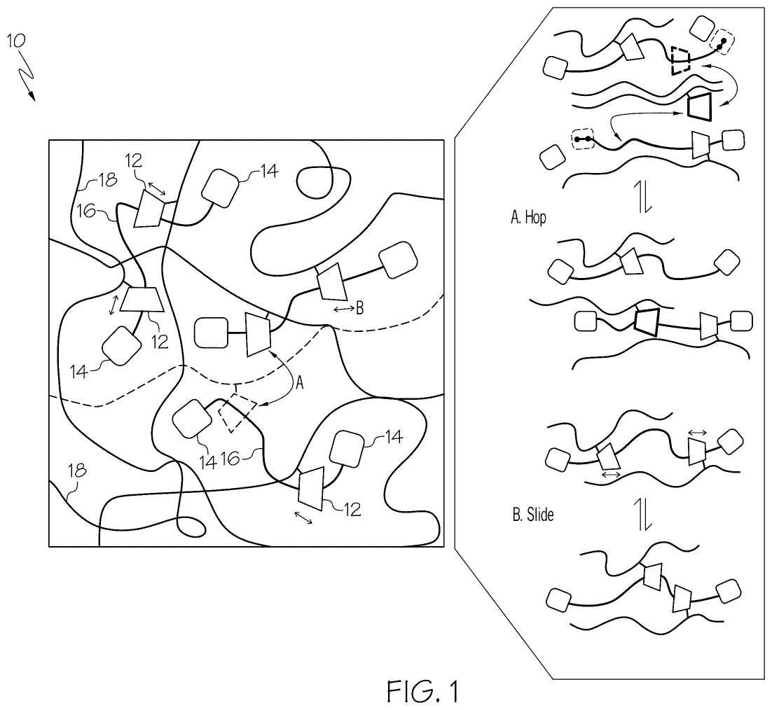

In some embodiments illustrated in FIG. 1, the present disclosure pertains to a rotaxane composition 10 that includes a plurality of macrocyclic rings 12, a plurality of macrocycle-binding moieties 14, and a plurality of first polymers 16 and second polymers 18. In some embodiments, the plurality of macrocyclic rings 12 and the plurality of macrocycle-binding moieties 14 are reversibly threaded onto the first polymers 16. In some embodiments, at least some of the plurality of macrocyclic rings 12 are operational to unthread from one first polymer 16 and rethread onto another first polymer 16 or a second polymer 18. As set forth in more detail herein, the compositions of the present disclosure can have numerous embodiments.

### First and Second Polymers

The compositions of the present disclosure can have numerous first and second polymers. For instance, in some embodiments, the first polymers and the second polymers are in the form of a network. In some embodiments, the network includes a cross-linked network.

In some embodiments, the first polymers and second polymers are not cross-linked to one another. In some embodiments, at least some of the first polymers and second polymers are cross-linked to one another. In some embodiments, at least some of the first polymers and second polymers are reversibly cross-linked to one another. In some embodiments, at least some of the first polymers and second polymers are reversibly cross-linked to one another through non-covalent crosslinkers.

In some embodiments, at least some of the threaded macrocyclic rings on the first polymers become threaded onto at least some of the second polymers. In some embodiments, at least some of the threaded macrocyclic rings on the first polymers move along the second polymer, thereby creating a network with mobile joints.

Macrocyclic rings may become reversibly threaded onto first or second polymers in various manners. For instance, in some embodiments, macrocyclic rings may become reversibly threaded onto first or second polymers through non-covalent interactions. In some embodiments, the non-covalent interactions include, without limitation, hydrogen bonding, electrostatic interactions, metal-ligand coordination, micro-crystallization, van der Waals forces, or combinations thereof.

In some embodiments, the first polymers and the second polymers are the same polymers. In some embodiments, the first polymers and second polymers are different polymers. In some embodiments, each of the first polymers and second polymers independently include, without limitation, nonionic polymers, ionic polymers, polyethylene glycol (PEG), poly(propylene oxide), polyalkyl ethers, polyacrylamide (PAAm), polymmethyl acrylate (PMA), polyacrylic acid (PAA), poly-N-(hydroxymethyl)acrylamide (PHMAm), poly(1-vinylpyrrolidone) (PVP), poly(Niisopropylacrylamide) (NIPAAm), poly(2-hydroxyethyl acrylate) (pHEA), telechelic polymers, or combinations thereof.

In some embodiments, the first polymers include polyethylene glycol (PEG). In some embodiments, the second polymers include polyacrylamide (PAAm). In some embodiments, the second polymers include a telechelic PEG polymer.

In some embodiments, each of the first and second polymers may include crystalline domains. In some embodiments, the first polymers may include crystalline domains. In some embodiments, the second polymers may include crystalline domains. In some embodiments, the first and second polymers may include crystalline domains.

### Macrocyclic Rings

The compositions of the present disclosure can include numerous macrocyclic rings. For instance, in some embodiments, the macrocyclic rings include cyclic oligosaccharides. In some embodiments, the macrocyclic rings include, without limitation, cyclodextrins, cyclodextrin derivatives, or combinations thereof.

In some embodiments, the macrocyclic rings include cyclodextrins. In some embodiments, the cyclodextrins include, without limitation, α-cyclodextrin (α-CD), β-cyclodextrin (β-CD), γ-cyclodextrin (γ-CD), acryloyl-piperazyl-modified-α-cyclodextrin (AP-CD), derivatives thereof or combinations thereof. In some embodiments, the cyclodextrins include, without limitation, α-cyclodextrin (α-CD), acryloyl-piperazyl-modified-α-cyclodextrin (AP-CD), derivatives thereof, or combinations thereof.

In some embodiments, the macrocyclic rings include different types of macrocyclic rings. In some embodiments, the plurality of macrocyclic rings include the same types of macrocyclic rings.

Macrocyclic rings and first polymers may be present in a composition at various molar ratios. For instance, in some embodiments, macrocyclic rings and first polymers may be present at a molar ratio of 1:1. In some embodiments, macrocyclic rings and first polymers may be present at a molar ratio of 1.4:1.

### Macrocycle-Binding Moieties

Macrocycle-binding moieties generally refer to compounds that can bind to macrocyclic rings. The compositions of the present disclosure can include various types of macrocyclic-binding moieties. For instance, in some embodiments, the macrocycle-binding moieties include, without limitation, cationic species, amines, diamines, alkylamines, tetraammonium moieties, charged imidazole moieties, pyridium moieties, butylenediamine, pentylenediamine, hexylenediamine, amino-cycloalkanes, camphors, cucurbit[n]uril, cucurbit[6]uril(CB[6]), cucurbit[7]uril(CB[7]), cucurbit[8]uril(CB[8]), derivatives thereof, or combinations thereof. In some embodiments, the macrocycle-binding moieties include cucurbit[6]uril(CB[6]).

In some embodiments, the macrocycle-binding moieties of the present disclosure may be appended to one or more ends of second polymers. In some embodiments, the macrocycle-binding moieties of the present disclosure may be appended to one or more ends of first polymers. In some embodiments, at least some of the first or second polymers are appended to a single macrocycle-binding moiety. In some embodiments, at least some of the first and second polymers are appended to a plurality of macrocycle-binding moieties. In some embodiments, the plurality of macrocycle-binding moieties are appended to at least some of the first or second polymers such that the plurality of macrocyclic rings are between the plurality of macrocycle-binding moieties (e.g., the plurality of macrocyclic rings 12 positioned between macrocycle-binding moieties 14, as illustrated in FIG. 1). In some embodiments, at least some of the macrocycle-binding moieties are operational to unthread from one first or second polymer and rethread onto the first or second polymer after the unthreading of one or more macrocyclic rings from the first or second polymer.

Macrocyclic-binding moieties and first polymers may be present in a composition at various molar ratios. For instance, in some embodiments, the macrocyclic-binding moieties and first polymers are present at a molar ratio of 1:1. In some embodiments, the macrocyclic-binding moieties and first polymers are present at a molar ratio of 2.5:1. In some embodiments, the macrocyclic-binding moieties and first polymers are present at a molar ratio of 5:1.

### Composition Forms and Properties

The compositions of the present disclosure may be in various forms. For instance, in some embodiments, the composition is in the form of a polymer network. In some embodiments, the composition is in the form of hydrogels. In some embodiments, the composition is in 3-D printable form.

The compositions of the present disclosure can include various advantageous properties. For instance, in some embodiments, the composition has a stretchability of at least 300 times its length. In some embodiments, the composition has a stretchability of at least 400 times its length. In some embodiments, the composition has a stretchability of at least 500 times its length. In some embodiments, the composition has a stretchability of at least 555 times its length.

In some embodiments, the composition has a toughness of at least 50 MJ/m³. In some embodiments, the composition has a toughness of at least 75 MJ/m³. In some embodiments, the composition has a toughness of at least 90 MJ/m³.

In some embodiments, the composition has a fracture toughness of at least 45 KJ/m². In some embodiments, the composition has a fracture toughness of at least 55 KJ/m². In some embodiments, the composition has a fracture toughness of at least 67 KJ/m².

### Methods of Manufacturing 3-D Structures

Additional embodiments of the present disclosure pertain to methods of manufacturing a three-dimensional structure. In some embodiments, the methods of the present disclosure include applying a composition of the present disclosure onto a surface to result in the formation of the three-dimensional structure on the surface.

In some embodiments, the applying occurs by additive manufacturing. For instance, in some embodiments, the compositions of the present disclosure may be loaded onto a digital light processing 3D-printer or a volumetric 3D-printer for photo-crosslinking. In some embodiments, the methods of the present disclosure also include a step of covalently cross-linking the three-dimensional structure. In some embodiments, the covalent cross-linking occurs by photo-irradiation. In some embodiments, the covalent cross-linking occurs by the addition of a cross-linking agent (e.g., bis-acrylamide) and an initiator (e.g., ammonium persulfate (APS)).

### Methods of Forming Rotaxane Compositions

Additional embodiments of the present disclosure pertain to methods of forming the rotaxane compositions of the present disclosure. In some embodiments, the methods of the present disclosure include: (1) reversibly threading a plurality of macrocyclic rings and a plurality of macrocycle-binding moieties onto a plurality of first polymers such that they become reversibly threaded onto the first polymers; and (2) associating the first polymers with a plurality of second polymers. In some embodiments, the methods of the present disclosure also include a step of (3) reversibly cross-linking at least some of the first polymers and second polymers to one another. As set forth in more detail herein, the methods of the present disclosure can have numerous embodiments.

Various methods may be utilized to thread macrocyclic rings and macrocycle-binding moieties onto first polymers. For instance, in some embodiments, threading includes polymerizing the first polymers in the presence of the macrocyclic rings and the macrocycle-binding moieties.

Various methods may also be utilized to associate first polymers and second polymers. For instance, in some embodiments, the association includes polymerizing the second polymers in the presence of the first polymers.

In some embodiments, at least some of the plurality of macrocyclic rings are able to unthread from one first polymer and rethread onto another first polymer or a second polymer. Suitable first and second polymers were described supra and are incorporated herein by reference. In some embodiments, the first polymers and the second polymers form a network. In some embodiments, the network includes a cross-linked network.

In some embodiments, at least some of the threaded macrocyclic rings on the first polymers become threaded onto at least some of the second polymers. In some embodiments, at least some of the threaded macrocyclic rings on the first polymers move along the second polymer, thereby creating a network with mobile joints.

Suitable macrocyclic rings and macrocycle-binding moieties were also described supra and are incorporated herein by reference. In some embodiments, at least some of the first polymers or second polymers become appended to a single macrocycle-binding moiety. In some embodiments, at least some of the first polymers or second polymers become appended to a plurality of macrocycle-binding moieties. In some embodiments, the plurality of macrocycle-binding moieties become appended to at least some of the first or second polymers such that the plurality of macrocyclic rings are between the plurality of macrocycle-binding moieties. In some embodiments, at least some of the macrocycle-binding moieties are able to unthread from one first polymer or second polymer and rethread onto the first polymer or second polymer after the unthreading of one or more macrocyclic rings from the first polymer.

The methods of the present disclosure may be utilized to form various types of compositions in various forms. For instance, in some embodiments, the formed composition is in the form of a polymer network. In some embodiments, the formed composition is in the form of hydrogels. In some embodiments, the formed composition is in 3-D printable form.

The methods of the present disclosure may be utilized to form various types of compositions with various properties. For instance, in some embodiments, the composition has a stretchability of at least 500 times its length. In some embodiments, the composition has a toughness of at least 90 MJ/m³. In some embodiments, the composition has a fracture toughness of at least 67 KJ/m².

### Additional Embodiments

Reference will now be made to more specific embodiments of the present disclosure and experimental results that provide support for such embodiments. However, Applicant notes that the disclosure below is for illustrative purposes only and is not intended to limit the scope of the claimed subject matter in any way.

### Example 1. Fabrication and Characterization of Ultra-Stretchable and Tough Hop-Ring Hydrogels

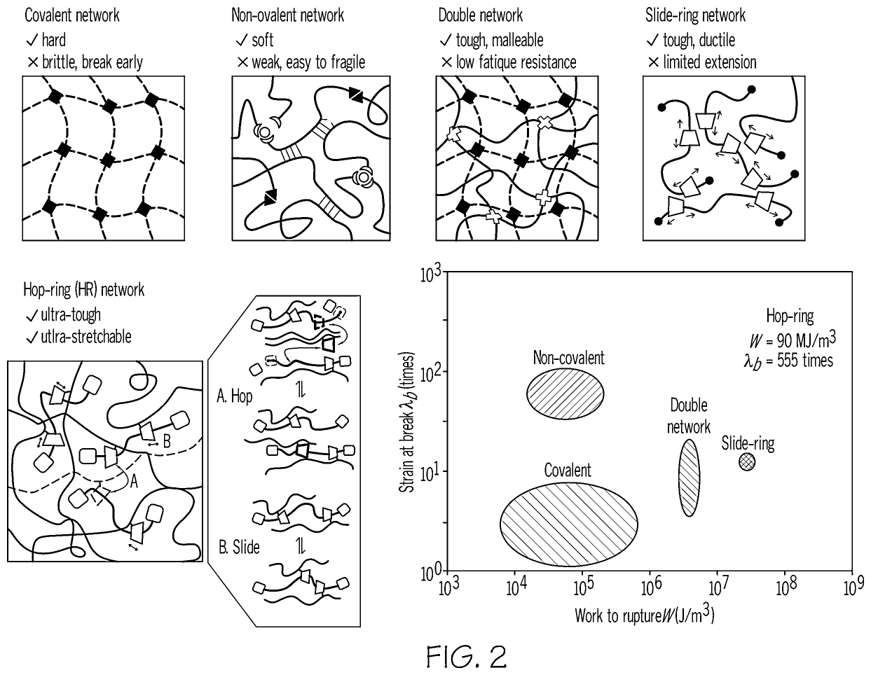

In this Example, Applicant designed ultra-stretchable and tough hydrogels by crosslinking polyacrylamide (PAAm) with a unique set of robust and dynamic mechanical interlocked crosslinkers. The as-prepared hydrogels, named as hop-ring gels, reached exceptional stretchability over 500 times, ultra-high toughness (90 MJ/m³), optimal fracture toughness (67 KJ/m²), and efficient reversibility. Remarkably, the hop-ring hydrogels have significantly exceeded the stretchability and toughness of covalent, physical, double-network, and slide-ring hydrogels reported previously (FIG. 2).

Applicant also unveiled a ring-hopping mechanism to elucidate why the gels can achieve surprisingly high stretchability while retaining outstanding toughness. The design of the distinctive hop-ring crosslinkers is based on a hetero-pseudorotaxane of cyclodextrin (CD), polyethylene glycol (PEG), and cucurbit[6]uril(CB[6]). An average of 1.4 acryloyl-piperazyl-modified-α-cyclodextrin (AP-CD) were threaded on each PEG chain, and copolymerized with acrylamide to form a loosely-crosslinked network. Two CB[6] strongly associated with 1,4-butanediamionium end groups of homo-telechelic PEG polymer. The formed robust host-guest complex noncovalently capped AP-CDs on the axle.

During deformations, AP-CDs first slide along the PEG chain until they eventually encountered CB[6] located at the chain ends. Attributed to the dynamic host-guest interactions, the collision between CB[6] and AP-CD did not cause any bond rupture. Instead, both CB[6] and AP-CD underwent dissociation/association processes: CB[6] detached and subsequently reattached to the end of the PEG polymer; AP-CD, which was grafted onto PAAm polymers, slid out of the PEG and then relocated to a different PEG polymer. This completed a single “hopping” process within the network.

The constantly hopping motions of the pseudorotaxane-based junctions rendered the hydrogels with remarkable properties. Specifically, the unique hopping movements has successfully decoupled the mutual confinement between stretchability and toughness, which are commonly observed in polymeric hydrogels. By tuning the binding behaviors of subcomponents (i.e., AP-CD, CB[6]) within the intricate topological structure, the ring-hopping process continuously took place to withstand extremely large deformations. The hop-ring gel possessed the highest strain at break of 555 times, superior to all the reported stretchable hydrogels, organogels, and elastomers. Maintaining extraordinarily low reactive sites per crosslinker (CD number per axle) and low crosslinker concentration is preferred to offer long sliding ranges and spacious relocating sites. Furthermore, the hop-ring hydrogels exhibited optimal toughness and good reversibility, thanks to the robust association between CB[6] and 1,4-butanediamionium, self-assembly of PEG chains, entanglements and H-bonding within PAAm chains.

### Example 1.1. Design and Synthesis of Hop-Ring Hydrogels

Different from typical crosslinkers containing no less than 2 reactive sites, an atypically low threading number of 1.4 reactive AP-CD per axle in the hop-ring crosslinker is preferred to maximize ting-hopping capability. An excessive of 2.5 CB per axle was added to ensure full capping at the 1,4-butanediammonium end groups of PEG (PEGₐₘᵢₙₑ). A free radical polymerization of the hetero-pseudorotaxane crosslinker and acrylamide was then conducted to form the hop-ring hydrogels in one pot. A commonly used thermal initiator ammonium persulfate (APS) was used. Despite the high-water content (70%) and low crosslinking concentration (5.8 mM), the hydrogel was super stretchable (strain at break, λb=555 times) due to the hopping rings from the crosslinker.

Additionally, the ring-hopping motions dissociated the mutual dependency between elasticity and stretchability. Therefore, the resilience of the hydrogel was not suppressed by its extreme extensibility. Rather, the young's modulus of hydrogels was improved to 290 kPa, rigidified by dense entanglements, multiple H-bonding, reversible but strong binding of CB at PEGₐₘᵢₙₑ end groups, as well as the self-assembled PEG crystalline domains.

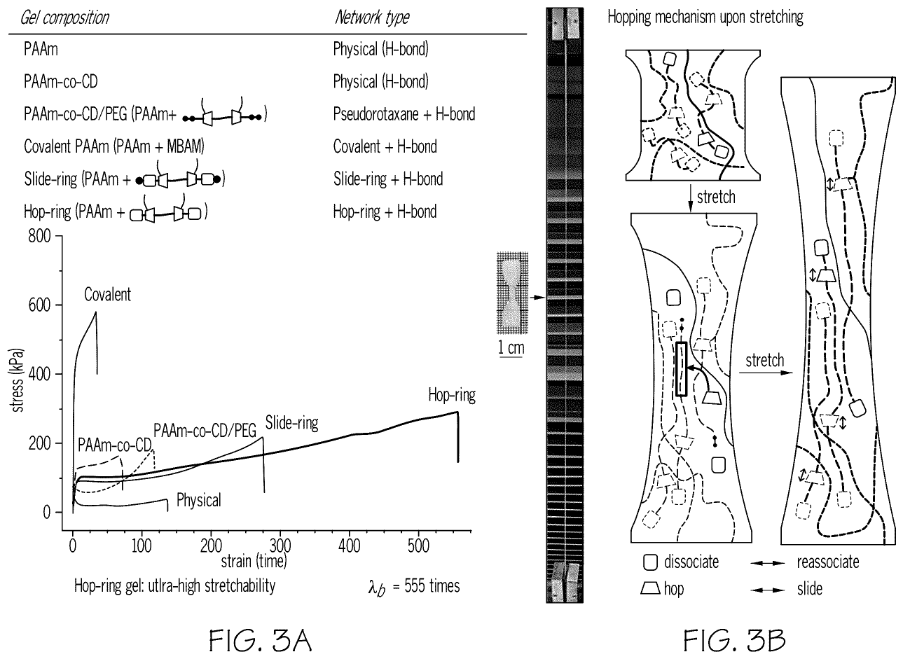

To evaluate the uniaxial tensile behavior of the hop-ring hydrogel, several gels composed of slide-ring, CB-uncapped, covalent, and physical PAAm networks were prepared and uniaxial stretched as control groups respectively. In FIG. 3A, physical PAAm hydrogel was crosslinked by weak and reversible H-bonding, leading to long stretchability (λb=times) but a low Young's modulus (E=kPa). The other physical hydrogel, PAAm-co-CD formed by polymerizing acrylamide and AP-CD, could be further stretched to 173 times due to the strengthened H-bond between acrylamide and CD species. However, both physical hydrogels remained soft (E=120 kPa). By adding PEGₐₘᵢₙₑ axle to thread CD and form pseudorotaxane crosslinks, the PAAm-co-CD/PEG gel became slightly more rigid (E=155 kPa) than physical PAAm-co-CD gel. Nevertheless, the stretchability was restrained caused by three possible factors: the pseudorotaxane crosslink being unstable with the absence of CB, the pseudorotaxane possessing 1.4 AP-CD per PEG on average, thus crosslinking inefficiently, and the presence of microphase separation between PEGamine and PAAm.

By contrast, the covalent PAAm interconnected by the same concentration of bisacrylamide, N,N′-methylenebisacrylamide (MBAM), showed brittleness (E=810 kPa) and poor stretchability (λb =33 times). Notably, the covalent network was significantly more stretchable than most covalent hydrogels (stretched less than 10 times) because of loosely crosslinked mesh and dense entanglements. Lastly, to prove that hopping played a dominant role in the remarkable stretchability and toughness, a hetero-rotaxane crosslinker was designed and prepared by CB-templated azide-alkyne cycloaddition reaction to restrict the movement of rings solely to sliding on PEG. The hetero-rotaxanes consist of threaded AP-CD, CB[6], and disubstituted PEG₆ₖ with propargylammonium end groups (PEG_{6k-prg}), which were blocked by forming tri-azole adduct with 1-(2-azidoethyl)-3,5-dimethylpyridinium chloride (DP_{N3}) catalyzed by CB.

The slide-ring hydrogels were prepared by one-pot free radical polymerization of the hetero-rotaxane crosslinker and acrylamide, and showed a promising stretchability up to 270 times higher than ever-reported slide-ring systems. However, the hop-ring hydrogels were able to extrapolate the “pulley effect” along one PEG axle to ring-hopping motion among multiple PEG axles, thus unprecedently leveling up the stretchability to 555 times (FIG. 3B). Moreover, both CB dissociation/association and PEG crystalline assemblies enhanced the energy absorption capability to reinforce hop-ring gels, resulting in a Young's modulus of 290 kPa, which is comparable to 275 kPa in slide-ring hydrogels. As hop-ring motions contributed to both stretchability and elasticity of the hydrogels, ultra-high toughness (W=89 MJ/m³) and fracture energy (Γ=67 KJ/m²) were achieved under substantial deformations. The presence of hop-ring motions has been proved to play a significant role in enhancing the stretchability and elasticity of the hydrogels. This ultimately leads to the remarkable achievement of ultra-high toughness (W=89 MJ/m³) and fracture energy (Γ=67 kJ/m²) of hop-ring hydrogels when subjected to substantial plastic deformations.

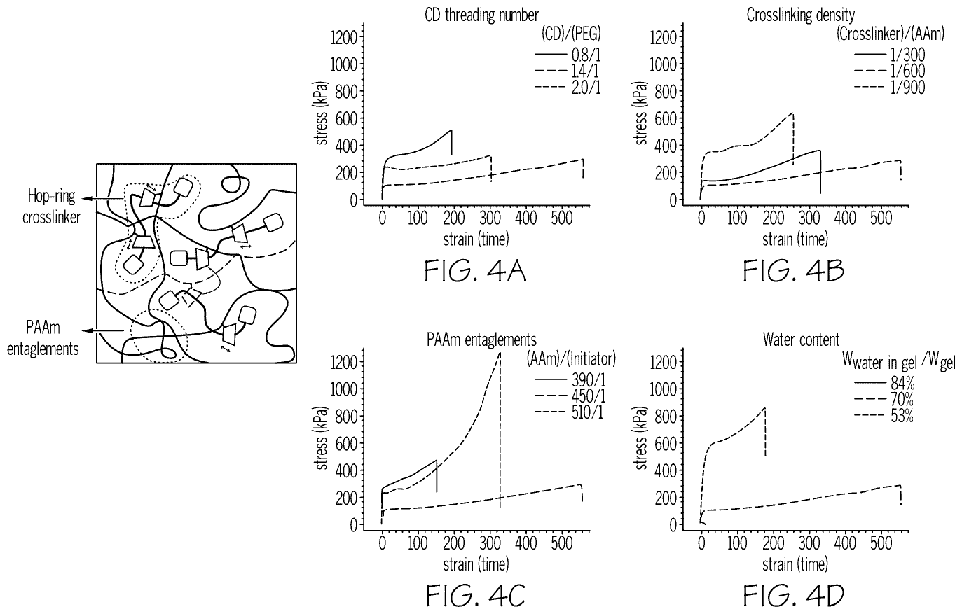

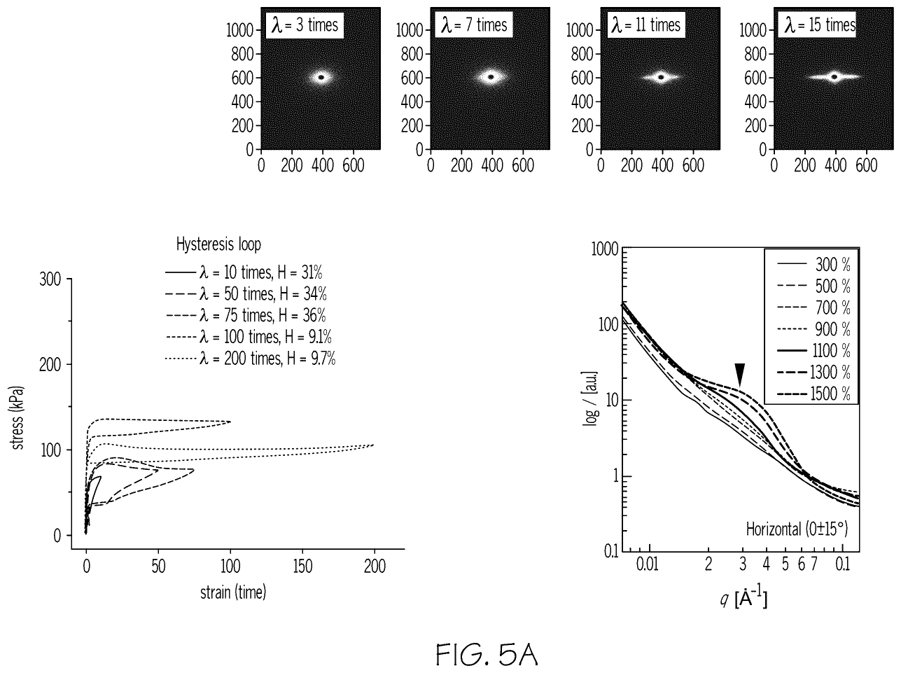

Applicant conducted serial uniaxial tensile tests to elucidate the influence of different hydrogel compositions on the hopping motions and bulky properties. Strain at break (λb), Young's modulus (E), and tensile strength (σb) are of interest, which provided a comprehensive mechanical understanding of the hop-ring systems. First, Applicant investigated the effect of the threading CD number per PEG axle ranging from 0.8 to 2 (FIG. 4A). When the average CD number was 0.8 per PEG axle, few hetero-pseudorotaxanes could act as a crosslinker, as most PEG could only thread with one CD. However, ring-sliding and hopping motions still occurred and released energy during stretching, resulting in a reasonably high stretchability of 193 times. Although the hydrogel was predominantly crosslinked through physical interactions, the modulus and strength increased dramatically, likely due to the enlarged size of PEG crystalline domain. The highest strain at break (λb=555 times) was observed in the hop-ring hydrogel with an average of 1.4 AP-CD per PEG axle. This implied that the crosslinking effect did occur as the 1.4 rings relocated among different axles. In this scenario, each ring possessed a sufficiently long sliding range along one PEG axle and plenty of relocation sites on the other axles. Furthermore, when every hop-ring crosslinker contained 2 AP-CD rings, both the slidable distance and available relocation space for the rings diminishes, decreasing stretchability to 300 times while enhancing Young's modulus to 400 kPa.

Next, Applicant set the threading CD number per axle as 1.4 and adjusted the concentrations of the hetero-pseudorotaxane crosslinker to investigate the impact of crosslinker density. Here, Applicant defined crosslinker concentration equal to PEG concentration. By raising the crosslinker concentration from 3.9 mM to 5.8 mM to 11.6 mM, the hop-ring networks could be stretched to 255 times, 555 times, and 332 times, respectively (FIG. 4B). Despite having an equivalent mobility among the hop-ring crosslinkers due to the fixed threading ring number, Applicant hypothesized that higher amounts of hop-ring crosslinkers would result in greater dissipation of energy. This hypothesis was confirmed as the strain at break increased from 255 times to 555 times when the crosslinker concentration increased from 3.9 mM to 5.8 mM.

Interestingly, as the crosslinking density further increased to 11.6 mM, the hydrogel became less capable of stretching ((λb=332 times), and the young's modulus decreased by over 50% to 130 kPa). This phenomenon occurred because the high concentration of pseudorotaxane crosslinkers caused strong microphase separation between PAAm and PEG, reducing the toughness of the gel. On the other hand, a lower concentration of water-soluble PEG resulted in less interference with the H-bonding within PAAm. This explained why the hop-ring gel with the lowest crosslinker content (3.9 mM) possessed high Young's modulus (E=273 kPa) and tensile strength (σb=640 kPa) (FIG. 4B).

Similar effects of microphase inhomogeneity have also been observed in PAAm-co-CD/PEG and PAAm/PEG/CB gels, which also exhibited reduced stretchability and elasticity (FIGS. 3A-3B).

The stiffening and toughening of hydrogels can be achieved by leveraging chain entanglements. In this Example, Applicant investigated the influence of PAAm entanglements in hop-ring systems. By increasing the amount of acrylamide during polymerization, Applicant was able to achieve stronger PAAm entanglements, resulting in highly stretchable and tough hydrogels. For example, when the acrylamide concentration was raised from 3 M to 3.5 M, the elongation at break improved from 152 times to 555 times, and the Young's modulus experienced a significant enhancement (FIG. 4C). However, excessive PAAm entanglements could in turn hinder the hopping process and lead to the rigidification of the hydrogel. For instance, when 4 M acrylamide was polymerized with the hop-ring crosslinker, the resulting gel exhibited significantly higher tensile strength but a decreased stretchability of 328 times.

Furthermore, Applicant explored the role of solid content in tuning the mechanical properties of the hop-ring hydrogel. The hop-ring hydrogel became much more stretchable and softer when lowering the solid content (FIG. 4D). However, if the solid content was too low, specifically at a value of 16%, gelation was not successful, indicating the requirement for a minimum solid content for successful gel formation.

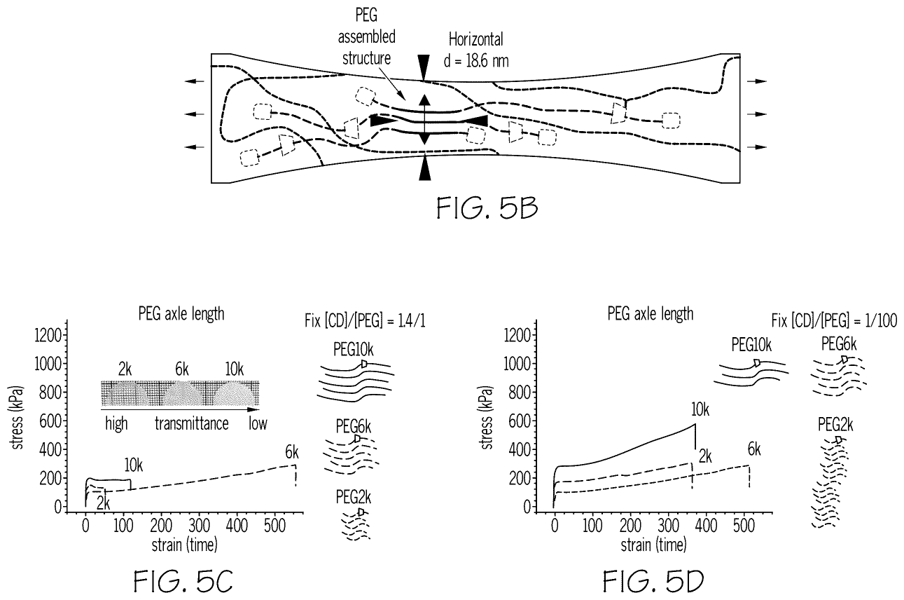

In addition to its outstanding elongation at break, the hop-ring hydrogel exhibited good reversibility when subjected to loadings. A low mechanical hysteresis of 10% was observed, especially when the extension ratio exceeded 100 times (FIG. 5A). This phenomenon implies that as the hydrogel was stretched to a significant extent, less energy was dissipated but restored within the hop-ring networks, resulting in a diminished lag between loading and unloading.

Similar to the PEG self-reinforcement observed in slide-ring hydrogels, Applicant observed strain-induced crystallization of PEG chains in hop-ring hydrogels as well. When the hop-ring gels were subjected to substantial deformations (λ=11 times), the stretched hop-ring gels began to show diffraction spots in the small-angle x-ray scattering (SAXS) (FIG. 5B). During the unloading process, the strain-induced crystalline phase disappeared. The reversible formation and destruction of the PEG crystals during loading and unloading cycles constituted the basis for the excellent mechanical reversibility of the hop-ring gels. Moreover, the reversible self-assembly of PEG facilitated the distribution of stress across a wide domain of the hop-ring network.

Consequently, the stored energy was deconcentrated and released to drive ring-hopping movements, ultimately contributing to the remarkable toughness and stretchability exhibited by the hop-ring hydrogel. To further investigate the formation and implications of PEG crystalline structures, Applicant synthesized hop-ring gels utilizing PEG axles with varying molecular weights. Specifically, hop-ring gels were fabricated using PEG axles with molecular weights of 2 k, 6 k, and 10 k, denoted as hop-ring2 k, hop-ring6 k, and hop-ring10 k gels. The selection of PEG molecular weights was based on their correlation with the mechanical properties of the gels for two reasons. First, longer PEG offered a greater range for ring-sliding and hopping, thus enhancing the stretchability of the resulting gels. Second, the microphase separation between PAAm and PEG was amplified by longer PEG chains, leading to increased inhomogeneity and weakening of the hydrogel. By balancing the two opposing effects, Applicant found that hop-ring 6 k gel could withstand extensions of up to 555 times, whereas hop-ring 2 k and hop-ring 10 k gels could only be stretched to 52 times and 117 times respectively (FIG. 5C).

Moreover, Applicant observed that, by augmenting the content of PEG2 k and reducing the content of PEG10 k, the stretchability of hop-ring2 k and hop-ring10 k gels could be significantly improved, even comparable with the performance of hop-ring6 k gel. Notably, within the hop-ring network, AP-CD could be threaded onto any PEG axles through the hopping movements. Therefore, Applicant found that, as long as the equivalent ratio of EG to CD was maintained at an optimized ratio of 100:1 (EG:CD=100:1), the hop-ring2 k, hop-ring6 k, hop-ring10 k gels displayed the highest level of stretchability (FIG. 5D).

### Example 1.2. Light-Based 3D Printing of Hop-Ring Hydrogels

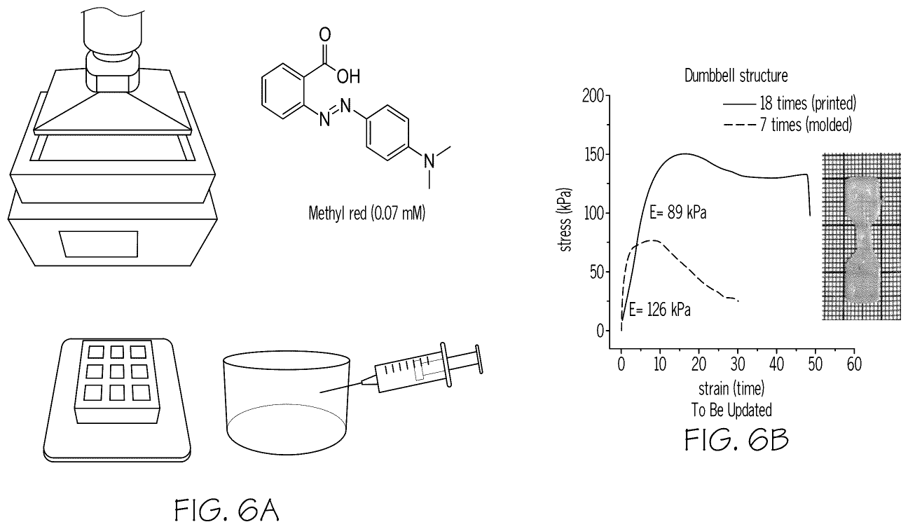

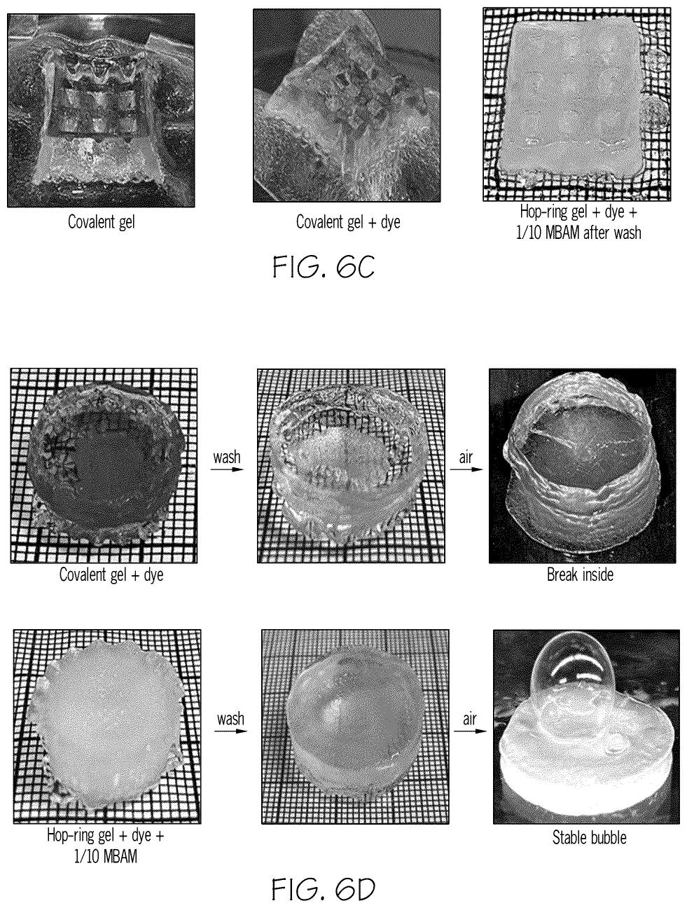

Applicant explored the processability and applicability of the hop-ring networks through additive manufacturing techniques. Digital light processing (DLP) was chosen as the printing method due to its capability to produce high-resolution, intricate, and flexible 3D structures at a rapid printing speed. Therefore, an LCD-based DLP printer was employed to fabricate hop-ring resins that could be initiated by light exposure (FIG. 6A).

To initiate the polymerization process, Applicant incorporated a water-soluble initiator, lithium phenyl-2,4,6-trimethylbenzoylphosphinate (LAP), into an aqueous solution of acrylamide and crosslinkers. Owing to the specific transmittance requirement of LCD printing and the poor solubility of CB[6], the precursor solution was filtered to remove undissolved CB[6] and obtain a translucent solution. To enhance the printing resolution, an organic water-soluble dye of methyl red, was added to facilitate light absorption. The 3D constructs were printed with an exposure time of 30 seconds per layer. Following the printing process, post-printing treatments were performed on the printed hydrogels by subjecting them to UV irradiation (W) for 20 min to complete the photopolymerization. The printed objects were then washed with a small amount of water to remove the dye.

To assess the mechanical properties of the printed hydrogels, Applicant first printed dumbbell-shaped hydrogels utilizing the same concentration of hop-ring and covalent crosslinkers. After printing and UV curing, the dumbbell specimens were subjected to uniaxial stretching to evaluate their stretchability. In FIG. 6B, the printed hop-ring gel showed superior stretchability in comparison to the printed covalent gel.

To showcase the capabilities of 3D printing, Applicant also fabricated cubic lattice structures using both covalent resins and hop-ring resins (FIG. 6C). Due to the inherently soft nature of the hop-ring hydrogel, Applicant introduced an additional portion of covalent crosslinker ( 1/10 of the hop-ring crosslinker concentration) to rigidify the self-supported structure. After curing and washing, both free-standing lattices demonstrated high fidelity and achieved a resolution of um.

Hollow objects could be readily printed with the assistance of DLP, which was challenging in extrusion-based printing methods. Cylinder-shaped objects containing a hollow chamber were successfully constructed using both hop-ring and covalent resin (FIG. 6D). Following the curing and washing steps, the geometries of both constructs were well-preserved. However, their shape-morphing and shape-resistant behavior were different. A syringe with a needle was used to purge air into the inner chamber. The tough hop-ring cylinder exhibited the formation of a large, durable bubble with a thin hydrogel layer that remained intact even after a week. Moreover, through continuously purging and contracting of air within the hydrogel chamber, the bubble exhibited repetitive expansion and contraction. In contrast, the covalently crosslinked object with the same geometry experienced immediate fracture upon air injection into the chamber.

Overall, the hop-ring network displayed exceptional material properties, imparting the fabricated hydrogel with remarkable resistance to severe deformations, high-pressure environments, and acute stress. This behavior also underscores the robustness and versatility of the hop-ring system in accommodating and sustaining extreme conditions.

### Example 1.3. Mechanical Tests of the Hop-Ring Hydrogels

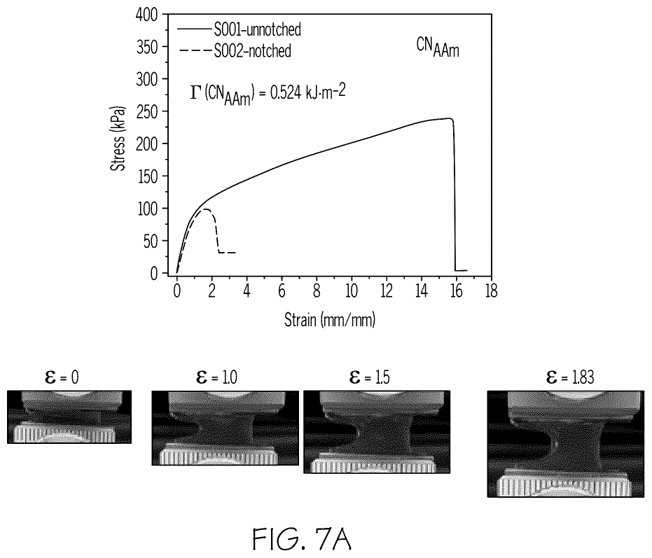

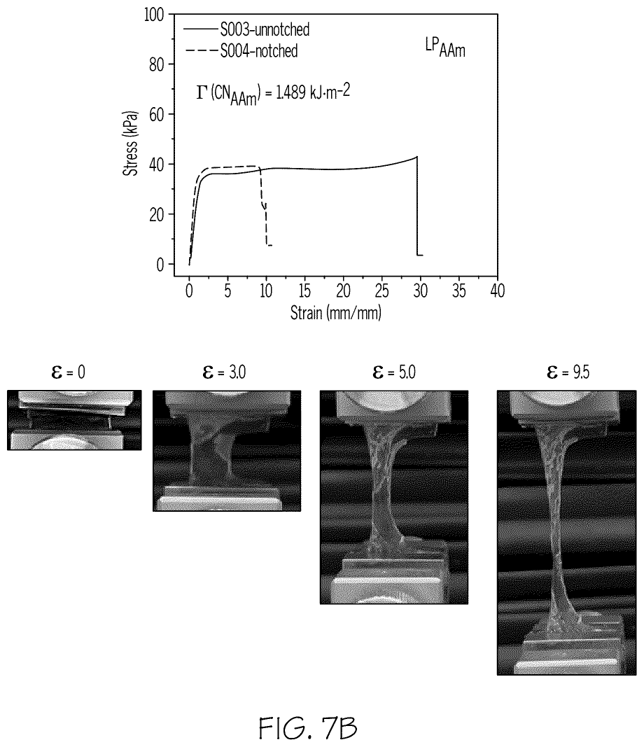

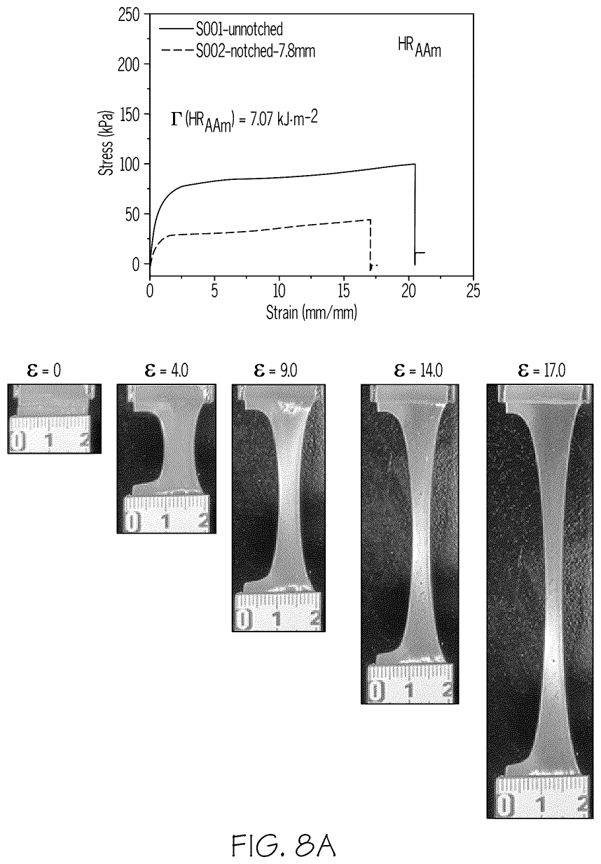

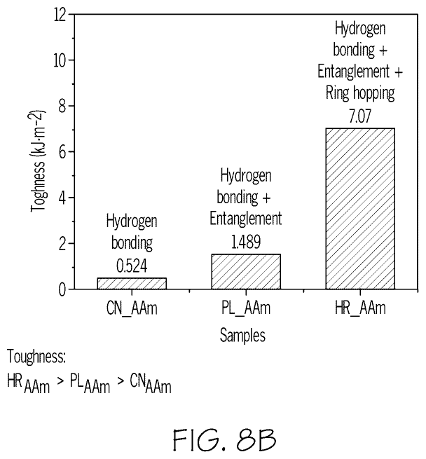

To compare the toughness of the hop-ring hydrogels with its single network counterparts, Applicant carried out tensile and fracture energy measurements. Results showed that the crack propagation is significantly retarded in the hop-ring hydrogel, and it has a significantly improved fracture toughness (FIGS. 7A-7B and 8A-8B).

### Example 1.4. Summary

The Example describes the development of ultra-stretchable and tough hydrogels, named hop-ring gels. These hydrogels are created by cross-linking polyacrylamide (PAAm) with a unique set of robust and dynamic hetero-pseudorotaxane-based crosslinkers. The aim of this Example is to decouple the mutual confinement between stretchability and toughness, which is commonly observed in polymeric hydrogels. The hop-ring gels demonstrate exceptional stretchability (over 500 times), ultra-high toughness (90 MJ/m³), and optimal fracture toughness (67 KJ/m²). These properties surpass those of previously reported covalent, physical, double-network, and slide-ring hydrogels.

The hop-ring hydrogels are designed with a ring-hopping mechanism facilitated by a hetero-pseudorotaxane of cyclodextrin (CD), polyethylene glycol (PEG), and cucurbit[6]uril(CB[6]). The crosslinkers consist of acryloyl-piperazyl-modified-a-cyclodextrin (AP-CD) threaded onto PEG chains, which are copolymerized with acrylamide to form a reversibly crosslinked network. CB[6] strongly associates with the end groups of the PEG polymer, forming robust host-guest complexes that noncovalently cap AP-CDs.

The hopping mechanism allowed for high stretchability without bond rupture, as CB[6] and AP-CD undergo dissociation/association processes during deformations. By tuning the binding behaviors of the subcomponents within the topological structure, the hop-ring gels exhibit the highest strain at break (555 times) compared to previously reported hydrogels, organo-gels, and elastomers. The hop-ring gels also demonstrate superior toughness and good reversibility. The robust association between CB[6] and PEG end groups, the self-assembly of PEG chains, chain entanglements and the H-bonding of PAAm contributed to these properties.

The hop-ring networks are also explored for their applicability in additive manufacturing techniques. The additive manufacturing techniques in this Example utilized digital light processing (DLP) for intricate and flexible 3D structure fabrication.

The hop-ring hydrogels address several problems and offer distinct advantages compared to existing technologies and approaches. First, the hop-ring hydrogels successfully decouple the mutual confinement between stretchability and toughness. This decoupling enables the hydrogels to withstand severe deformations while maintaining their mechanical integrity. Second, the hop-ring hydrogels exhibit exceptional high stretchability, ultra-high toughness, and excellent fracture toughness. Third, the hop-ring hydrogels demonstrate good processability, allowing for their fabrication using additive manufacturing techniques, such as DLP. This enables the production of intricate and flexible 3D structures, opening up possibilities for market adoption in various applications such as surgical sutures, wound dressings, and tissue engineering.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

1. A rotaxane composition comprising:
a plurality of macrocyclic rings;
a plurality of macrocycle-binding moieties; and
a plurality of first polymers and second polymers,
wherein the plurality of macrocyclic rings and the plurality of macrocycle-binding moieties are reversibly threaded onto the first polymers, and
wherein at least some of the plurality of macrocyclic rings are operational to unthread from one first polymer and rethread onto another first polymer or a second polymer.

2. The composition of claim 1, wherein at least some of the first polymers and second polymers are reversibly cross-linked to one another.

3. The composition of claim 1, wherein the first polymers and second polymers are different polymers.

4. The composition of claim 1, wherein each of the first polymers and second polymers are independently selected from the group consisting of nonionic polymers, ionic polymers, polyethylene glycol (PEG), poly(propylene oxide), polyalkyl ethers, polyacrylamide (PAAm), polymmethyl acrylate (PMA), polyacrylic acid (PAA), poly-N-(hydroxymethyl)acrylamide (PHMAm), poly(1-vinylpyrrolidone) (PVP), poly(Niisopropylacrylamide) (NIPAAm), poly(2-hydroxyethyl acrylate) (pHEA), telechelic polymers, or combinations thereof.

5. The composition of claim 1, wherein the first polymers comprise polyethylene glycol (PEG), and wherein the second polymers comprise polyacrylamide (PAAm).

6. The composition of claim 1, wherein the macrocyclic rings comprise cyclodextrins.

7. The composition of claim 6, wherein the cyclodextrins are selected from the group consisting of a-cyclodextrin (a-CD), β-cyclodextrin (β-CD), γ-cyclodextrin (γ-CD), acryloyl-piperazyl-modified-a-cyclodextrin (AP-CD), derivatives thereof or combinations thereof.

8. The composition of claim 6, wherein the cyclodextrins are selected from the group consisting of a-cyclodextrin (a-CD), acryloyl-piperazyl-modified-a-cyclodextrin (AP-CD), derivatives thereof, or combinations thereof.

9. The composition of claim 1, wherein the macrocyclic rings and first polymers are present at a molar ratio of 1.4:1.

10. The composition of claim 1, wherein the plurality of macrocycle-binding moieties are selected from the group consisting of cationic species, amines, diamines, alkylamines, tetraammonium moieties, charged imidazole moieties, pyridium moieties, butylenediamine, pentylenediamine, hexylenediamine, amino-cycloalkanes, camphors, cucurbit[n]uril, cucurbit[6]uril(CB[6]), cucurbit[7]uril(CB[7]), cucurbit[8]uril(CB[8]), derivatives thereof, or combinations thereof.

11. The composition of claim 1, wherein the macrocycle-binding moieties comprise cucurbit[6]uril(CB[6]).

12. The composition of claim 1, wherein the macrocyclic-binding moieties and first polymers are present at a molar ratio of 2.5:1.

13. The composition of claim 1, wherein the plurality of macrocycle-binding moieties are appended to at least some of the first or second polymers such that the plurality of macrocyclic rings are between the plurality of macrocycle-binding moieties.

14. The composition of claim 1, wherein at least some of the macrocycle-binding moieties are operational to unthread from one first or second polymer and rethread onto the first polymer or second polymer after the unthreading of one or more macrocyclic rings from the first or second polymer.

15. The composition of claim 1, wherein the composition has a stretchability of at least 500 times its length, a toughness of at least 90 MJ/m³, and a fracture toughness of at least 67 KJ/m².

16. A method of manufacturing a three-dimensional structure, said method comprising:
applying a rotaxane composition onto a surface, wherein the rotaxane composition comprises:
a plurality of macrocyclic rings;
a plurality of macrocycle-binding moieties; and
a plurality of first polymers and second polymers,
wherein the plurality of macrocyclic rings and the plurality of macrocycle-binding moieties are reversibly threaded onto the first polymers, and
wherein at least some of the plurality of macrocyclic rings are operational to unthread from one first polymer and rethread onto another first polymer or a second polymer, and
wherein the applying results in the formation of the three-dimensional structure on the surface.

17. The method of claim 16, wherein the applying occurs by additive manufacturing.

18. The method of claim 16, further comprising a step of covalently cross-linking the three-dimensional structure.

19. The method of claim 18, wherein the covalent cross-linking occurs by photo-irradiation.

20. The method of claim 18, wherein the covalent cross-linking occurs by the addition of a cross-linking agent.

21. A method of forming a rotaxane composition, said method comprising:
reversibly threading a plurality of macrocyclic rings and a plurality of macrocycle-binding moieties onto a plurality of first polymers, wherein the plurality of macrocyclic rings and the plurality of macrocycle-binding moieties become reversibly threaded onto the first polymers; and
associating the first polymers with a plurality of second polymers, wherein at least some of the plurality of macrocyclic rings are able to unthread from one first polymer and rethread onto another first polymer or a second polymer.

22. The method of claim 21, further comprising a step of reversibly cross-linking at least some of the first polymers and second polymers to one another.

23. The method of claim 21, wherein each of the first polymers and second polymers are independently selected from the group consisting of nonionic polymers, ionic polymers, polyethylene glycol (PEG), poly(propylene oxide), polyalkyl ethers, polyacrylamide (PAAm), polymethyl acrylate (PMA), polyacrylic acid (PAA), poly-N-(hydroxymethyl)acrylamide (PHMAm), poly(1-vinylpyrrolidone) (PVP), poly(Niisopropylacrylamide) (NIPAAm), poly(2-hydroxyethyl acrylate) (pHEA), telechelic polymers, or combinations thereof.

24. The method of claim 21, wherein the first polymers comprise polyethylene glycol (PEG), and wherein the second polymers comprise polyacrylamide (PAAm).

25. The method of claim 21, wherein the macrocyclic rings comprise cyclodextrins selected from the group consisting of a-cyclodextrin (a-CD), β-cyclodextrin (β-CD), γ-cyclodextrin (γ-CD), acryloyl-piperazyl-modified-a-cyclodextrin (AP-CD), derivatives thereof or combinations thereof.

26. The method of claim 21, wherein the plurality of macrocycle-binding moieties are selected from the group consisting of cationic species, amines, diamines, alkylamines, tetraammonium moieties, charged imidazole moieties, pyridium moieties, butylenediamine, pentylenediamine, hexylenediamine, amino-cycloalkanes, camphors, cucurbit[n]uril, cucurbit[6]uril(CB[6]), cucurbit[7]uril(CB[7]), cucurbit[8]uril(CB[8]), derivatives thereof, or combinations thereof.

27. The method of claim 21, wherein the threading comprises polymerizing the first polymers in the presence of the macrocyclic rings and the macrocycle-binding moieties.

28. The method of claim 21, wherein the associating comprises polymerizing the second polymers in the presence of the first polymers.
